(19) United States
(12) Patent Application Publication
(10) Pub. No.: US 2024/0047894 A1
(43) Pub. Date: Feb. 8, 2024

(54) ANTENNA DEVICE

(71) Applicant: KYOCERA Corporation, Kyoto-shi, Kyoto (JP)

(72) Inventors: Yoshihide OKAWA, Kirishima-shi (JP); Sentarou YAMAMOTO, Kagoshima-shi (JP)

(73) Assignee: KYOCERA Corporation, Kyoto-shi, Kyoto (JP)

(21) Appl. No.: 18/268,729

(22) PCT Filed: Dec. 10, 2021
(86) PCT No.: PCT/JP2021/045615

§ 371 Date: Jun. 21, 2023

(30) Foreign Application Priority Data
Dec. 28, 2020 (JP) 2020-219293

(51) Int. Cl. H01Q 21/06; H01Q 1/02; H01Q 1/22

(52) U.S. Cl. CPC H01Q 21/065; H01Q 1/02; H01Q 1/2283

(57) ABSTRACT

An antenna device includes a first substrate and an antenna. The first substrate has a through hole penetrating in the thickness direction. The antenna includes a second substrate and an element portion including a circuit unit on the second substrate. The second substrate is located in the through hole with a gap from the first substrate.

### CROSS-REFERENCE TO RELATED APPLICATIONS

This application is national stage application of International Application No. PCT/JP2021/045615, filed on Dec. 10, 2021, which designates the United States, incorporated herein by reference, and which claims the benefit of priority from Japanese Patent Application No. 2020-219293, filed on Dec. 28, 2020, the entire contents of which are incorporated herein by reference.

### TECHNICAL FIELD

An embodiment of the disclosure relates to an antenna device.

### BACKGROUND OF INVENTION

Conventionally, a structure in which an antenna is mounted on a substrate has been disclosed.

### CITATION LIST

### Patent Literature

Patent Document 1: WO 2018/168391 A1

### SUMMARY

An antenna device according to an aspect of an embodiment includes a first substrate and an antenna. The first substrate has a through hole penetrating in a thickness direction. The antenna includes a second substrate and an element portion including a circuit unit on the second substrate. The second substrate is located in the through hole with a gap from the first substrate.

### BRIEF DESCRIPTION OF THE DRAWINGS

FIG. 1 is a plan view illustrating a main portion of an antenna device according to an embodiment.

FIG. 2 is a cross-sectional view taken along Il-Il in FIG. 1.

FIG. 3 is a cross-sectional view schematically illustrating the antenna device according to the embodiment.

### DESCRIPTION OF EMBODIMENTS

An embodiment of an antenna device disclosed in the present application will be described in detail below. The present invention is not limited by the following embodiments.

### Embodiment

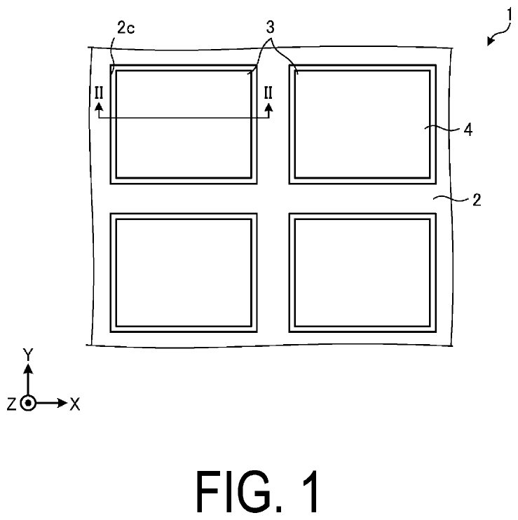

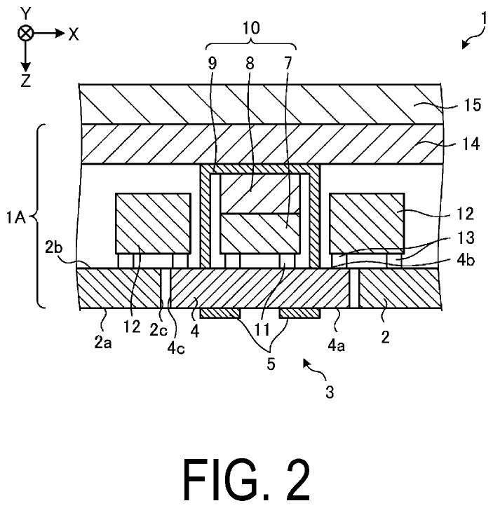

The configuration of an antenna device according to an embodiment will be described with reference to FIGS. 1 and 2. FIG. 1 is a plan view illustrating a main portion of an antenna device according to an embodiment. FIG. 2 is a cross-sectional view taken along Il-Il in FIG. 1.

As illustrated in FIGS. 1 and 2, an antenna device 1 includes a first substrate 2 and an antenna 3.

The first substrate 2 has a plurality of through holes 2c penetrating in the thickness direction (Z-axis direction). The through holes 2c have a quadrangular prism shape, for example, and open in a first surface 2a and a second surface 2b located at both ends in the thickness direction (Z-axis direction) of the first substrate 2. Here, the first substrate 2 may have a through hole 2c having a depth less than the length of the side having the smallest length among the sides of the through hole 2c, and even in such a case, the through hole 2c may be referred to as a through hole 2c in a quadrangular prism shape. The same applies to a through hole 2c having a hexagonal prism shape or the like indicated as a structure other than the quadrangular prism shape. The side of the through hole 2c is one side of a quadrangular shape when the shape of the through hole 2c when the first substrate 2 is viewed in plan view in the Z-axis direction is a quadrilateral shape as described above. The sides of the through hole 2c are sides of opening portions extending along the first surface 2a and the second surface 2b of the first substrate 2. Surfaces of the first substrate 2 extending from the opening portion of the first surface 2a to the opening portion of the second surface 2b are defined as inner walls.

The plurality of through holes 2c are arranged at predetermined intervals along the X axis and the Y axis intersecting the X axis. The shape of the through hole 2c is not limited to a quadrangular prism shape, and may be, for example, a hexagonal prism shape, an octagonal prism shape, or another prism shape, or may be any column shape such as a circular column shape or an elliptical column shape. The plurality of through holes 2c of the first substrate 2 may be arrayed in a rectangular lattice as illustrated in FIG. 1, or may be arrayed in any manner such as an orthorhombic lattice, a triangular lattice, or a hexagonal lattice, for example. The plurality of through holes 2c may be arranged irregularly.

For the sake of clarity, FIG. 1 illustrates a three-dimensional orthogonal coordinate system with an X axis and a Y axis corresponding to directions in which the plurality of through holes 2c are arrayed and a Z axis corresponding to a direction intersecting an XY plane. Such an orthogonal coordinate system is also presented in the other drawings used in the description below. In the following description, the negative side in the Z-axis direction may be referred to as “up” for convenience. The same and/or similar components as those of the antenna device 1 illustrated in FIG. 1 are denoted by the same reference signs, and descriptions thereof will be omitted or simplified.

The antenna 3 includes a second substrate 4, a conductor portion 5, and an element portion 10. The antenna 3 is positioned so as to be fitted into the through hole 2c provided in the first substrate 2. In FIG. 1, only the second substrate 4 is illustrated as the antenna 3, and other components including the conductor portion 5 are not illustrated.

As illustrated in FIG. 1, the second substrate 4 has a quadrangular prism shape. When the thickness of the second substrate 4 is smaller than the length of the shortest side among the sides of the second substrate 4, the second substrate 4 may be a flat plate having a quadrilateral shape (or a rectangular shape) when viewed in plan view. In FIG. 1 the shape of the second substrate 4 when viewed in plan view is illustrated as an example; however, the shape of the second substrates 4 may be a shape with rounded corners. Other shapes such as a hexagonal prism shape described below may also have rounded corners.

Here, the second substrate 4 will be described in detail. The second substrate 4 has a third surface 4a and a fourth surface 4b located at both ends of the second substrate 4 in the thickness direction (Z-axis direction), and a side surface 4c located between the third surface 4a and the fourth surface 4b.

The side surface 4c of the second substrate 4 is located facing the through hole 2c provided in the first substrate 2 with a gap from the through hole 2c. In other words, the side surface 4c of the second substrate 4 is located away from the wall surface of the through hole 2c. When the first substrate 2 and the second substrate 4 are located away from each other in this manner, air can flow through the gap between the first substrate 2 and the second substrate 4. Therefore, the antenna device 1 of the embodiment can efficiently release heat generated in the antenna 3, thus exhibiting a high heat dissipation property. Here, the interval between the side surface 4c of the second substrate 4 and the through hole 2c may be, for example, about 0.5 mm.

The second substrate 4 is fixed to the first substrate 2. Examples of the method of fixing the second substrate 4 to the first substrate 2 include a method in which a plate is attached to the first surface 2a of the first substrate 2 so as to protrude into the through hole 2c.

The first substrate 2 and the second substrate 4 are, for example, wiring boards. The first substrate 2 and the second substrate 4 may be, for example, multilayer wiring boards which are located along the XY plane and in which layers each including an organic resin as an insulating layer are layered in the Z-axis direction. The second substrate 4 may be, for example, a dielectric substrate containing a dielectric material. The second substrate 4 may be an AIP (Antenna In Package). The thicknesses of the first substrate 2 and the second substrate 4 may be equal or different.

The shape of the second substrate 4 is not limited to a quadrangular prism shape, and may be, for example, a hexagonal prism shape, an octagonal prism shape, or another prism shape, a circular column shape, or an elliptical prism shape. The second substrate 4 may be located such that the side surface 4c and the through hole 2c are equally spaced over the entire second substrate 4. The second substrate 4 may be located such that the interval in the X-axis direction and the interval in the Y-axis direction are different from each other, for example.

The conductor portion 5 is located on the third surface 4a of the second substrate 4. The conductor portion 5 is a patch, for example, and may be an electrical conductor film made of an electrically conductive material such as copper, for example. The conductor portion 5 may include a copper foil, or copper plating.

As illustrated in FIG. 2, when the antenna device 1 is actually used, the conductor portion 5 is located below a circuit unit 7. Therefore, heat generated in the circuit unit 7 is less likely to be transmitted to the conductor portion 5 side. On the other hand, heat generated in the conductor portion 5 is dissipated as air flows through the gap between the first substrate 2 and the second substrate 4. Accordingly, the heat transport capacity of the antenna device 1 can be enhanced.

The element portion 10 is mounted on the fourth surface 4b. The element portion 10 includes the circuit unit 7, a first heat dissipation body 8, and a heat dissipation member 9.

The circuit unit 7 is, for example, an integrated circuit. The circuit unit 7 may include, for example, an integrated circuit such as a radio frequency integrated circuit (RFIC). The circuit unit 7 is electrically connected to the second substrate 4 via a first connecting member 11 to be described later. The RFIC may be, for example, a high electron mobility transistor (HEMT) or a heterojunction bipolar transistor (HBT).

The first connecting member 11 is located on the fourth surface 4b of the second substrate 4. The first connecting member 11 has a predetermined height in the thickness direction of the second substrate 4, and connects the second substrate 4 and the circuit unit 7. The first connecting member 11 may be a bump in a columnar shape, for example. By positioning the first connecting member 11 between the second substrate 4 and the circuit unit 7, heat generated in the circuit unit 7 is more easily transmitted to the first heat dissipation body 8 than to the second substrate 4. Therefore, the heat dissipation property can be enhanced as compared with the case where the second substrate 4 and the circuit unit 7 are brought into contact with each other without interposing the first connecting member 11 therebetween. The first connecting member 11 is indicated as an example of a connecting member. The first connecting member 11 may be a so-called solder ball.

The first heat dissipation body 8 is located between the heat dissipation member 9 and the circuit unit 7. The first heat dissipation body 8 may be, for example, a thermal interface material (TIM). The first heat dissipation body 8 contains, for example, carbon. When the first heat dissipation body 8 contains carbon, the thermal conductivity can be increased as compared with the case where the first heat dissipation body 8 does not contain carbon. The first heat dissipation body 8 may contain, for example, an organic resin such as an epoxy resin or a silicone resin.

The surface of the first heat dissipation body 8 may have adhesive properties. When the surface of the first heat dissipation body 8 has adhesive properties, the circuit unit 7 and the heat dissipation member 9 can be bonded to each other without interposing, for example, an adhesive material or another member. The first heat dissipation body 8 may be located over the entire surface of the circuit unit 7 facing the heat dissipation member 9. When the first heat dissipation body 8 is located over the entire surface of the circuit unit 7 facing the heat dissipation member 9, the heat dissipation member 9 and the circuit unit 7 can be bonded to each other with no gap therebetween, thereby increasing the heat transfer surface area. This can enhance the heat transport capacity.

The first heat dissipation body 8 may have a layered structure. When the first heat dissipation body 8 is layered, organic resin films having different elastic moduli may be layered in the thickness direction (Z-axis direction), for example. For example, when using the first heat dissipation body 8 whose surface facing the circuit unit 7 or the heat dissipation member 9 has adhesive properties and whose inside has high strength, for example, the first heat dissipation body 8 is less likely to be peeled off or damaged, and the antenna device 1 having high strength can be obtained. In this case, the material of the surface of the first heat dissipation body 8 and the material of the inside thereof may have different constituents.

The heat dissipation member 9 accommodates the circuit unit 7. For example, the heat dissipation member 9 seals the circuit unit 7 between the heat dissipation member 9 and the second substrate 4, and suppresses exposure of the circuit unit 7. The heat dissipation member 9 may have, for example, a lid shape covering the periphery of the circuit unit 7. The heat dissipation member 9 may be, for example, a heat spreader configured to promote rapid heat dissipation from the circuit unit 7. The material of the heat dissipation member 9 may be, for example, an aluminum alloy or another metal. The material of the heat dissipation member 9 may be, for example, a resin such as a thermosetting resin or a photo-curable resin. The heat dissipation member 9 may also be, for example, made of a metal in consideration of mechanical strength, thermal resistance, and thermal conductivity. For example, when the heat dissipation member 9 is made of a metal and the entire upper and lower surfaces of the first heat dissipation body 8 are bonded to the circuit unit 7 and the heat dissipation member 9 as illustrated in FIG. 2, heat dissipation from the element portion 10 can be enhanced.

The heat dissipation member 9 may have a single-layer structure, or may have a structure in which a metal plate and an organic resin film (organic resin plate) are layered, for example. The heat dissipation member 9 may be made of a metal on the outer side and an organic resin on the inner side in order to reduce sensitivity to the ambient temperature, for example.

The antenna device 1 further includes an interposer 12, a second heat dissipation body 14, and a first support member 15.

The interposer 12 connects the first substrate 2 and the second substrate 4. The interposer 12 is electrically connected to wiring included in each of the first substrate 2 and the second substrate 4 via a second connecting member 13 to be described later.

The second connecting member 13 is located on each of the second surface 2b of the first substrate 2 and the fourth surface 4b of the second substrate 4. The second connecting member 13 has a predetermined height in the thickness direction of the second substrate 4 and connects the first substrate 2 and the second substrate 4 to the interposer 12. The second connecting member 13 is indicated as an example of a connecting member. The second connecting member 13 may be a bump in a columnar shape, for example.

By positioning the second connecting member 13 between the first substrate 2 and the second substrate 4 and the interposer 12, air can flow through the gap between the first substrate 2 and the second substrate 4. Therefore, according to the antenna device 1 of the embodiment, it is possible to efficiently dissipate heat generated in the antenna 3, in particular the conductor portion 5, and thus the heat dissipation property can be improved. The second connecting member 13 may be a so-called solder ball. The second connecting member 13 may have the same shape and/or material as the first connecting member 11, or may have a different shape and/or material from the first connecting member 11.

When the first substrate 2 and the second substrate 4 are located along the XY plane, the height of the second connecting member 13 provided on the first substrate 2 and the height of the second connecting member 13 provided on the second substrate 4 are close to each other. The amount of elongation of the second connecting member 13 provided on the first substrate 2 and the amount of elongation of the second connecting member 13 provided on the second substrate 4 are close to each other. Accordingly, the reliability of connection of the interposer 12 to the first substrate 2 and the second substrate 4 can be enhanced.

The heights of the second surface 2b of the first substrate 2 and the fourth surface 4b of the second substrate 4 may be different from each other due to, for example, variations in the mounting process. For example, the fourth surface 4b of the second substrate 4 may be higher than the second surface 2b of the first substrate 2, and a step may be formed between the second surface 2b and the fourth surface 4b.

The height difference (step size) between the second surface 2b of the first substrate 2 and the fourth surface 4b of the second substrate 4 may be 1/10 or more and ½ or less of the height (length) of the second connecting member 13. In a structure in which the difference between the height of the fourth surface 4b of the second substrate 4 and the height of the second surface 2b of the first substrate 2 is 1/10 or more and ½ or less of the height of the second connecting member 13, the height of the second connecting member 13 on the element portion 10 side is greater. Therefore, the gap between the fourth surface 4b of the second substrate 4 and the interposer 12 is larger than the gap between the second surface 2b of the first substrate 2 and the interposer 12. Accordingly, air flowing from the side of the first surface 2a of the first substrate 2 and the third surface 4a of the second substrate 4 through the through hole 2c easily flows to the element portion 10 side, thereby cooling the element portion 10 easily.

The second heat dissipation body 14 is located between the heat dissipation member 9 and the first support member 15. The second heat dissipation body 14 may be, for example, a thermal interface material (TIM). The material and characteristics of the second heat dissipation body 14 may be, for example, the same as those of the first heat dissipation body 8 described above.

The first support member 15 supports the antenna 3. The first support member 15 is fixed to the heat dissipation member 9 via the second heat dissipation body 14. The material of the first support member 15 may be, for example, a metal material such as copper or aluminum. The first support member 15 may be a part of a casing of the antenna device 1. Subsequently, an example of the overall configuration of the antenna device 1 will be described. Here, a portion constituted by the first substrate 2, the antenna 3, the first connecting member 11, the interposer 12, the second connecting member 13, and the second heat dissipation body 14 is referred to as an antenna device body 1A for convenience.

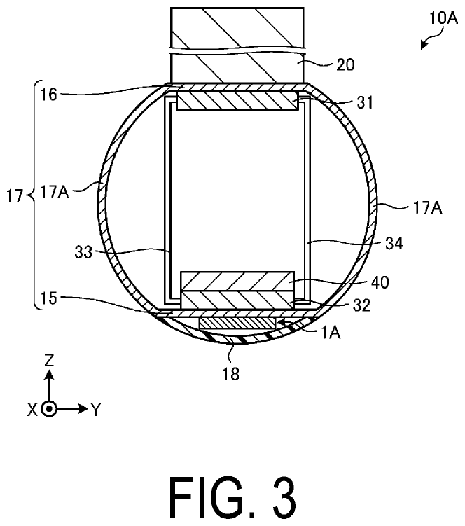

FIG. 3 is a cross-sectional view schematically illustrating an antenna device structure 10A according to the embodiment. As illustrated in FIG. 3, an antenna device structure 10A includes a casing 17, a radome 18, a support 20, a first base member 31, a second base member 32, fixing members 33 and 34, a power supply unit 40, and the antenna 3. In other words, the antenna device structure 10A includes the antenna device body 1A described above, the casing 17, the radome 18, the support 20, and the power supply unit 40. In FIG. 3, the antenna 3 and components located in the vicinity of the antenna 3 such as the first substrate 2, for example, are not illustrated.

The casing 17 includes a first support member 15, a second support member 16, and a curved support portion 17A. The casing 17 has a substantially spherical outer surface. The curved support portion 17A has a circular shape when the sphere is cut along the XY plane.

The first support member 15 illustrated in FIG. 3 is a flat portion of the casing 17 that is in contact with the antenna device body 1A. The second support member 16 is a flat portion of the casing 17 that is in contact with the support 20. The curved support portion 17A is a portion of the casing 17 other than the first support member 15 and the second support member 16.

The first support member 15 is located so as to be in contact with the second base member 32. The second support member 16 is located so as to be in contact with the first base member 31.

The material of the first support member 15 and the second support member 16 may be, for example, a metal such as copper. The material of a portion (curved support portion 17A) of the casing 17 other than the first support member 15 and the second support member 16 may be, for example, a metal such as aluminum or an aluminum alloy.

The first support member 15 and the second support member 16 are located at both ends of the casing 17 in the height direction (Z-axis direction). The support 20 and the first base member 31 are mounted on the second support member 16 located on the positive side in the Z-axis direction, of the first support member 15 and the second support member 16. The second base member 32 and the antenna 3 are mounted on the first support member 15 located at an end portion of the casing 17 on the negative side in the Z-axis direction.

The radome 18 protrudes in a spherical crown shape from the first support member 15 toward the negative side in the Z-axis direction. The radome 18 is made of a material such as polytetrafluoroethylene, for example, which covers the conductor portion 5 and does not suppress transmission of radio waves emitted from the antenna 3.

Here, the radius of curvature of the casing 17 (curved support portion 17A) and the radius of curvature of the radome 18 are preferably equal. When the radius of curvature of the casing 17 (curved support portion 17A) and the radius of curvature of the radome 18 are equal, there is no protruding portion, no sharply curved portion, or no recessed portion on the outer surfaces of the casing 17 and the radome 18. Therefore, the casing 17 and the radome 18 have high resistance to external pressure such as an external impact. This increases the durability of the casing 17.

The support 20 is located on the upper side (on the positive side in the Z-axis direction) of the second support member 16. The support 20 is shaped to be elongated in the Z-axis direction. Examples of the shape of the support 20 include a quadrangular prism shape. The support 20 may be, for example, a member made of a metal such as an aluminum alloy. A plurality of through holes extending in the Z-axis direction may be provided inside the support 20. Accordingly, the heat dissipation property of the antenna device 1 can be further enhanced.

The first base member 31 is located on the lower side (on the negative side in the Z-axis direction) of the second support member 16. The second base member 32 is located on the upper side (on the positive side in the Z-axis direction) of the first support member 15. The first base member 31 and the second base member 32 are made of a metal such as copper, for example, and contribute to heat dissipation of the antenna device 1 from the first base member 31 side to the second base member 32 side, for example. Since the first base member 31 and the second base member 32 are not in contact with each other, the first base member 31 and the second base member 32 also contribute to heat dissipation accompanying movement of outside air, for example. The first base member 31 and the second base member 32 may be solid bodies, or may be hollow bodies having a flow path therein.

The fixing members 33 and 34 are hollow or solid members having both ends mounted on the first base member 31 and the second base member 32, respectively. The fixing members 33 and 34 are, for example, composed of a metal member such as copper. The fixing members 33 and 34 position the first base member 31 and the second base member 32 so as to face each other with a predetermined interval therebetween and contribute to heat dissipation. The fixing members 33 and 34 may be heat pipes which are tubular bodies in which a cooling medium is sealed. Each of the fixing members 33 and 34 may be composed of a plurality of members. Only one of the fixing members 33 and 34 need be provided.

The power supply unit 40 supplies power to the antenna 3. The power supply unit 40 converts electrical power output from an external power supply (not illustrated) to a predetermined electrical power value as necessary and supplies the converted power to the antenna 3.

### Experimental Example

The heat dissipation property of the antenna device 1 illustrated in FIG. 2 was evaluated for a difference due to the presence or absence of a gap between the side surface 4c of the second substrate 4 and the through hole 2c.

The following materials were used for the antenna device 1 according to an experimental example. The first substrate 2 had dimensions in both the X-axis direction and the Y-axis direction of 50 mm, and a thickness of 1 mm. The through hole 2c had dimensions in both the X-axis direction and the Y-axis direction of 5 mm. The second substrate 4 had dimensions in both the X-axis direction and the Y-axis direction of 4 mm, and a thickness of 1 mm. The interval between the side surface 4c of the second substrate 4 and the through hole 2c was 0.5 mm. The height of the interposer 12 from the second surface 2b of the first substrate 2 was 0.5 mm. The circuit unit 7 had dimensions in both the X-axis direction and the Y-axis direction of 2 mm. The supplied electrical power was 9 W. Both the first heat dissipation body 8 and the second heat dissipation body 14 had a thickness of 0.1 mm, and were mounted on the first support member 15 having a thickness of 2 mm. The second substrate 4 was supported by a plate mounted on the first surface 2a of the first substrate 2 so as to protrude toward the through hole 2c side.

The first substrate 2, the second substrate 4, and the interposer 12 had coefficients of thermal conductivity of 10 W/mK (X-axis direction and Y-axis direction) and 1 W/mK (Z-axis direction). The circuit unit 7, the first heat dissipation body 8 and the second heat dissipation body 14, and the first support member 15 had coefficients of thermal conductivity of 4.3 W/mK, 50 W/mK, and 385 W/mK, respectively.

On the other hand, an antenna device according to a reference example was fabricated using the same materials as those of the antenna device 1 according to the above-described experimental example except that the dimensions of the through hole 2c in the X-axis direction and the Y-axis direction were both 4 mm. Since the dimensions of the second substrate 4 in the X-axis direction and the Y-axis direction were both 4 mm, the size of the second substrate 4 coincided with the size of the through hole 2c formed in the first substrate 2.

When the antenna devices 1 according to the experimental example and the reference example were evaluated under the same energization conditions, it was found that the temperature at a location immediately below the conductor portion 5 was 100° C. or less in the antenna device 1 according to the experimental example, and that the antenna device 1 according to the experimental example had a heat dissipation property suitable for the intended use. On the other hand, the temperature at a location immediately below the conductor portion 5 exceeded 100° C. in the antenna device according to the reference example. Accordingly, it was found that the heat dissipation property was improved by positioning the side surface 4c of the second substrate 4 away from the through hole 2c.

Further effects and variations can be readily derived by those skilled in the art. Thus, a wide variety of aspects of the present invention are not limited to the specific details and representative embodiments represented and described above. Accordingly, various changes are possible without departing from the spirit or scope of the general inventive concepts defined by the appended claims and their equivalents.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An antenna device comprising:
a first substrate having a through hole penetrating in a thickness direction of the first substrate; and
an antenna comprising:
a second substrate located in the through hole, and an element portion comprising a circuit unit on the second substrate, wherein
a gap separates the second substrate from the first substrate.

2. The antenna device according to claim 1, wherein
the element portion comprises a heat dissipation member that accommodates the circuit unit.

3. The antenna device according to claim 1, wherein
the antenna comprises a conductor portion located on a surface of the second substrate opposite to the circuit unit.

4. The antenna device according to claim 1, further comprising:
an interposer that connects the first substrate and the second substrate via a connecting member, wherein
the interposer faces the first substrate and the second substrate.

5. The antenna device according to claim 1, wherein:
the element portion comprises a heat dissipation body located on the circuit unit, and between a heat dissipation member that accommodates the circuit unit; and
the heat dissipation body is bonded to the heat dissipation member.

6. An antenna device comprising:
a first substrate comprising a through hole, and
an antenna comprising:
a second substrate positioned in the through hole and separated from the first substrate by a circumferential gap,
an element portion on a first surface of the second substrate, the element portion including a circuit unit.

7. The antenna device according to claim 6, further comprising
an interposer that straddles at least a portion of the gap, and that includes a connecting member that connects the first substrate to the second substrate.

8. The antenna device according to claim 6, wherein
the element portion further includes:
a heat dissipation body on a surface of the circuit unit that is opposite to the first surface of the second substrate; and
a heat dissipation member on the first surface of the second substrate that encloses the circuit unit and the heat dissipation body, wherein
the heat dissipation body is bonded to the heat dissipation member.

9. The antenna device according to claim 6, wherein
the antenna further comprises a conductor portion located on a second surface of the second substrate that is opposite to the first surface.

10. An antenna device comprising:
a first substrate having a through hole penetrating in a thickness direction of the first substrate from a first surface side to a second surface side;
an antenna, comprising:
a second substrate located in the through hole, wherein a gap separates the second substrate from the first substrate, and
an element portion on the first surface side of the second substrate, the element portion comprising a circuit unit; and
an interposer that straddles the gap on the first surface side to connect the first substrate and the second substrate.

11. The antenna device according to claim 10, further comprising:
a connecting member that connects the interposer to the first substrate and the second substrate.

12. The antenna device according to claim 11, wherein
the interposer electrically connects wiring in the first substrate to wiring in the second substrate via the connecting member.

13. The antenna device according to claim 11, wherein
the connecting member comprises a first connecting member that connects the first substrate to the interposer and a second connecting member that connects the second substrate to the interposer.

14. The antenna device according to claim 11, wherein
the connecting member has a predetermined height in the thickness direction.

15. The antenna device according to claim 13, wherein
the first connecting member and the second connecting member have a columnar shape.

16. The antenna device according to claim 13, wherein the first connecting member and the second connecting member have a bump shape.

17. The antenna device according to claim 13, wherein
the first connecting member and the second connecting member have a non-columnar shape.
